(19) United States
(12) Patent Application Publication
(10) Pub. No.: US 2012/0096758 A1
(43) Pub. Date: Apr. 26, 2012

(54) PLASTIC COATED DEER TAIL HAIR BAIT

(76) Inventor: James Judson, Thomson, IL (US)

(21) Appl. No.: 13/278,132

(22) Filed: Oct. 20, 2011

Related U.S. Application Data
(60) Provisional application No. 61/394,955, filed on Oct. 20, 2010.

(51) Int. Cl. A01K 85/00

(52) U.S. Cl. 43/42.28; 43/42.53

(57) ABSTRACT

A plastic coated deer tail hair bait includes a casing that includes a soft plastic; and a length of deer tail hair; wherein the plastic casing retains the hair so that a portion of the hair extends from the casing. A method includes heating a soft plastic to over 300 degrees F.; retaining a length of deer hair in a two-part mold so that a portion of the hair extends from the mold; and transferring the plastic to the mold so as to form a casing that retains the hair.

### RELATED APPLICATIONS

This application claims the benefit of the filing date of U.S. Patent Application No. 61/394,955, filed Oct. 20, 2010, which is incorporated herein by reference in its entirety.

### BACKGROUND OF THE INVENTION

The present invention generally relates to fishing lures and more specifically to plastic coated deer tail hair bait.

Fishermen want to use a variety of jig sizes, colors and color combinations to use in varied water conditions, such as those of wind, water and depth.

It would be desirable to have a fishing lure that includes deer tail as a hair bat.

### SUMMARY OF THE INVENTION

In one aspect of the present invention, a fishing lure includes a casing that includes a soft plastic; and a length of deer tail hair; wherein the plastic casing retains the hair so that a portion of the hair extends from the casing.

In another aspect of the present invention, a method of providing a fishing lure includes heating a soft plastic to over 300 degrees F.; retaining a length of deer hair in a two-part mold so that a portion of the hair extends from the mold; and transferring the plastic to the mold so as to form a casing that retains the hair.

### BRIEF DESCRIPTION OF THE DRAWINGS

FIG. 1 depicts a side view of embodiment of a fishing lure with hairs according to the present invention;

FIG. 2 depicts a cross section view of the embodiment of FIG. 1.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

Broadly, an embodiment of the present invention generally provides a fishing lure, comprising deer tail bait, for example hair from the tail of a buck, embedded in a soft plastic body. The preparation of the bait eliminates the need to use tools used in jig tying and allows the bait to be attached to jigheads of various sizes.

Embodiments of a deer or buck tail jig may be prepared by tying lengths of buck tail hair onto a jighead. The jighead, which may be molded in lead, may be secured in a fly tying vise and strands of buck tail hair may be tied onto the jighead using a bobbin and fly tying thread to hold the buck tail hair in place on the jig. If a fisherman intends to use various sizes of jigs and colors of buck tail hair using this method, he may have assorted sizes and colors of buck tail jigs.

According to an exemplary embodiment of the invention, a deer tail hair lure may be made by made by encasing a length of deer tail hair in soft plastic using a mold. An embodiment may be attached to a jighead or hook of various sizes that the fisherman or other user may select by slipping the plastic coated bait over the hook and using it to go fishing. By pushing the bait over the hook past the barb and against the jighead, a user may allow the hook to puncture and hold the bait.

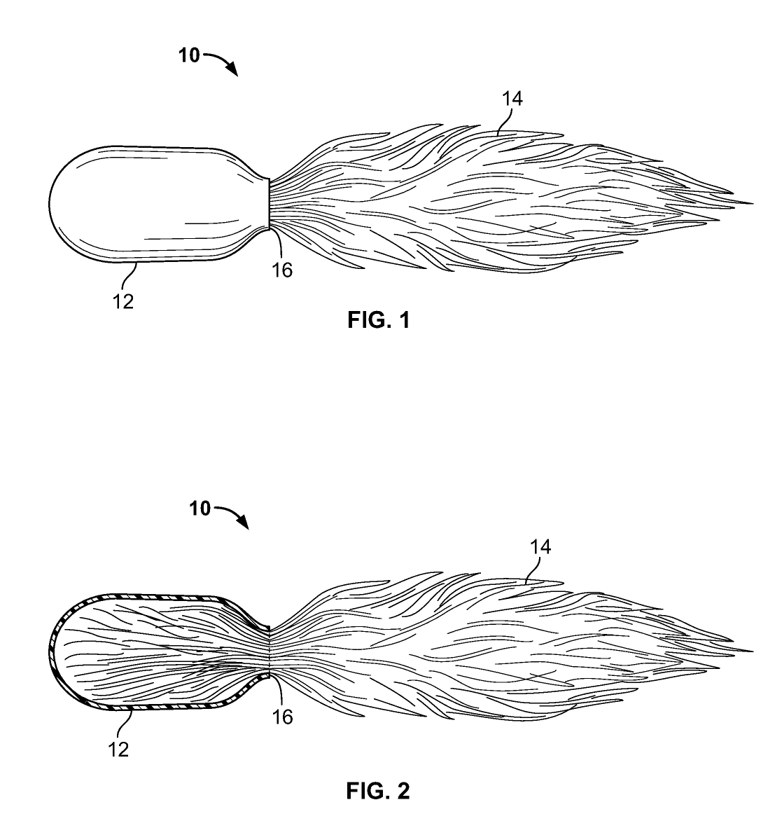

As depicted in the embodiment of FIG. 1, a fishing lure 10 may include a case 12 and a plurality of deer hairs 14 that extend out of an opening 16.

As depicted in the embodiment of FIG. 2, a fishing lure 10 may have an opening 16 that allows the hairs 14 to extend from the case 12. The opening 16 may constrict around the hairs 14 to retain the hairs 14 in place.

In an embodiment, to make the deer tail bait, hair may be cut off the deer tail to whatever length the user may desire for the bait and placed into a two-part mold in which the two parts may be clamped together. A mold having sizes ranging from 3/16 inches by ⅜ inches to 1 inch by 3 inches may be used. The mold may have 3-dimensional elongated oval shape. Dyed natural deer tail is available commercially and may be found in colors not limited to black, white, yellow, green, red, blue, purple, olive, brown, pink, orange, fluorescent white, fluorescent yellow, fluorescent green, fluorescent red, fluorescent blue, light blue, fluorescent purple, fluorescent pink. The same colors are available in synthetic hair, which may also be used.

To make an embodiment, a selected color of plastic may be secured from companies that sell tackle-crafting supplies used in crafting plastic baits. This plastic may be heated to over 300° F. before use. Once the plastic reaches the desired temperature, it can be transferred to a small injector and poured into the two-part mold containing the length of deer hair. A rod could be placed in the mold to create a cavity for the hairs.

After all the cavities of the mold are filled, the two-part mold can be unclamped and the plastic coated baits taken out. The sprue or other excess plastic can then be cut off, for example with scissors. When the casing cools, it may provide constriction to retain the hair fibers.

Embodiments of the plastic may be reheated to the desired temperature, for example, the same temperature used for molding, and the plastic portion of the bait can be dipped down into hot plastic. The second coating with plastic may be used to cover any areas of the deer tail bait that have not been completely coated with plastic and also to give the bait a high gloss finish. The plastic coated deer tail hair bait may then be dropped into a container of cold water to solidify the plastic.

In a solid body hair grub bait embodiment, each half of a 2-part mold may have 10 cavities. Each cavity may be filled to approximately one half full of hot plastic. This is done to allow for shrinkage incurred. After this portion of the process is completed, the mold may be clamped together for the next step of the process. Buck tail, tinsel, synthetic, or another hair is then cut to the desire length and placed into the mold through an opening at the top. A piece of tubing is placed into the hair. This will create a sprue and seal at the opening so the hot plastic has only one place to flow when the next step is started. Each cavity is then injected with hot plastic, so that the plastic flows to form the casing. The mold is unclamped; the bait is taken out, trimmed, and is ready for the last process. Each individual bait is then dipped into hot plastic to cover over any flaws and to also give it a more appealing shine. They parts are then quenched in a vessel of water to solidify the plastic.

In a hollow body hair bait embodiment, the two part mold is loaded with hair, tinsel, or a synthetic material. A metal or hard plastic rod is inserted through the hair to a desire length. It is then injected with hot plastic. A user then may take the bait, trim it, and dip the material back into the hot plastic, quench, and pull the rods out of the tube baits.

The deer tail hair baits may then be slipped over the hook of a selected jighead or hook for use in fishing.

Embodiments of a deer tail hair bait according to the present invention may fit on perhaps 7 or 8 sizes of buck tail jigheads, providing the needed versatility. Sizes may include 1″, 1.5″, and other sizes.

In an embodiment, the deer tail hair extends out from the one end of the lure and also goes completely to the other end inside of the plastic. Embodiments may be provided in multiple sizes.

Embodiments may include a fishing lure, comprising a deer tail hair encased in plastic and adapted to be attached to a jighead or fish hook.

I claim:

1. A fishing lure, comprising:
a casing that includes a soft plastic; and
a length of deer tail hair;
wherein the plastic casing retains the hair so that a portion of the hair extends from the casing.

2. The lure of claim 1, wherein the casing substantially consists of the soft plastic, molded to retain the hair.

3. The lure of claim 1, wherein the hair includes a plurality of hairs of a buck deer tail.

4. The lure of claim 1, wherein the hair includes died deer hairs, thereby providing an artificially colored deer hair bait.

5. The lure of claim 1, wherein the hair extends into the casing through an opening at a first end of the casing, and the hair reaches a second, closed end of the casing that is opposite the first end.

6. The lure of claim 5, wherein the opening of the casing is constricted around the hairs so as to retain the hairs.

7. The lure of claim 1, further comprising a second outer coating of plastic

8. A method of providing a fishing lure, comprising::
heating a soft plastic to over 300 degrees F.;
retaining a length of deer hair in a two-part mold so that a portion of the hair extends from the mold; and
transferring the plastic to the mold so as to form a casing that retains the hair.

9. The method of claim 8, wherein the hair extends into the casing through an opening at a first end of the casing, and the hair reaches a second, closed end of the casing that is opposite the first end.

10. The method of claim 8, wherein the opening of the casing is constricted around the hairs so as to retain the hairs.

11. The method of claim 8, wherein the casing is dipped into a second coating of hot plastic.

12. The method of claim 8, wherein the casing is dipped into a second coating of hot plastic and then the casing is dipped into cold water to solidify the plastic.

13. The method of claim 8, further comprising: placing a rod in the mold to form a cavity for the hairs.

14. The method of claim 8, further comprising:
forming a 2-part mold, each mold having a plurality of cavities; and
adding to each cavity a quantity of hot plastic.

15. The method of claim 14, further comprising:
clamping the mold together to form a casing;
cutting the hair to a desired length;
placing the hair through an opening in the top of the casing;
unclamping the mold; and
trimming the sprue from the casing.

16. The method of claim 14, further comprising:
dipping the casing into hot plastic to cover flaws; and
quenching the casing in water.
